(19) United States
(12) Patent Application Publication
(10) Pub. No.: US 2011/0191749 A1
(43) Pub. Date: Aug. 4, 2011

(54) SYSTEM AND METHOD FOR GENERATING ENTERPRISE APPLICATIONS

(76) Inventor: Martijn Van Liebergen, Deventer (NL)

(21) Appl. No.: 12/696,277

(22) Filed: Jan. 29, 2010

(51) Int. Cl. G06F 9/44

(52) U.S. Cl. 717/105; 717/122

(57) ABSTRACT

There is provided a computer system (102) for generating an enterprise application (123). The computer system (102) comprises a processor (112) adapted to execute stored instructions, and a memory device (122) that stores instructions for execution by the processor (112). The memory device (122) comprises computer-implemented code adapted to receive a reference enterprise application (121). The reference enterprise application (121) comprises one or more projects. Additionally, the reference enterprise application (121) comprises a first executable software application. The memory device (122) further comprises computer-implemented code adapted to receive a configuration (124). The configuration (124) identifies a subset of the projects to be included in the enterprise application (123). The memory device (!22) additionally comprises computer-implemented code adapted to generate the enterprise application (123) based on the reference enterprise application (121) and the configuration (124). The generated enterprise application (123) comprises a second executable software application.

### BACKGROUND

Software development is a resource intensive, time-consuming process. Unfortunately, follow-on software development may waste resources by not exploiting the knowledge and assets gained from prior development efforts. This leads to repeated hand-crafting of software solutions, which drives up the costs of development and maintenance. These issues are a hindrance to productivity and competitiveness in the marketplace.

Software development tools may help to take better advantage of existing resources. However, the typical software development tools are relatively complex, and raise issues with ease of use. In recent years, software development tools have advanced to become easier to use. Yet, the software that these tools are used to help create, is becoming more complex. As such, it falls to the more experienced and senior developers to efficiently develop complex software using the typical software development tool.

The typical business organization may have a limited number of senior developers on staff. As such, developing complex software using the typical software development tool may be an insufficient aid to cost-effective software development.

### BRIEF DESCRIPTION OF THE DRAWINGS

Certain exemplary embodiments are described in the following detailed description and in reference to the drawings, in which:

FIG. 1 is a block diagram of a system adapted for generating an enterprise application according to an exemplary embodiment of the present invention;

FIG. 2 is a process flow diagram of a computer-implemented method for generating an enterprise application according to an exemplary embodiment of the present invention;

FIG. 3 is a process flow diagram of a computer-implemented method for generating an enterprise application according to an exemplary embodiment of the present invention; and

FIG. 4 is a block diagram showing a tangible, machine-readable medium that stores code adapted for generating an enterprise application according to an exemplary embodiment of the present invention.

### DETAILED DESCRIPTION

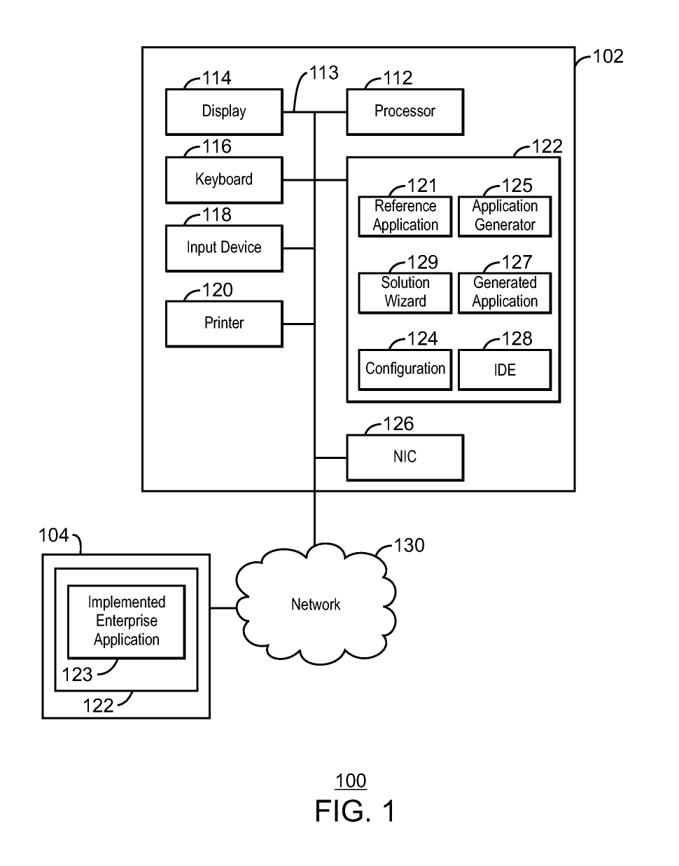

FIG. 1 is a block diagram of a system adapted to generating an enterprise application according to an exemplary embodiment of the present invention. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium or a combination of both hardware and software elements.

Additionally, the functional blocks and devices of the system 100 are but one example of functional blocks and devices that may be implemented in an exemplary embodiment of the present invention. Those of ordinary skill in the art would readily be able to define specific functional blocks based on design considerations for a particular electronic device.

The system 100 may include a development computer 102, and an implementation architecture 104, in communication over a network 130. In an exemplary embodiment of the invention, a user operating the development computer 102 may develop enterprise applications for implementation on the implementation architecture 104. The implementation architecture 104 may range in from a small-scale single personal computer to a full web server with database applications.

As illustrated in FIG. 1, the development computer 102 may include one or more processors 112. The processors 112 may be connected through a bus 113 to a display 114, a keyboard 116, one or more input devices 118, and an output device, such as a printer 120. The input devices 118 may include devices such as a mouse or touch screen.

The development computer 102 may have other units operatively coupled to the processor 112 through the bus 113. These units may include tangible, machine-readable storage media, such as storage devices 122.

The storage devices 122 may include media for the long-term storage of operating software and data, such as hard drives. The storage devices 122 may also include other types of tangible, machine-readable media, such as read-only memory (ROM), random access memory (RAM), and cache memory. The storage devices 122 may include the data and software used in exemplary embodiments of the present techniques.

The development computer 102 may also be connected through the bus 113 to a network interface card (NIC) 126. The NIC 126 may connect the development computer 102 to the network 130. The network 130 may be a local area network (LAN), a wide area network (WAN), or another network configuration, such as the Internet. The network 130 may include routers, switches, modems, or any other kind of interface device used for interconnection.

Through the network 130, the development computer 102 may connect to the implementation architecture 104. The implementation architecture 104 may be similarly structured as the development computer 102, with exception to the data and software included in the storage devices 122. As shown, the storage devices 122 on the implementation architecture 104 may include an implemented enterprise application 123.

On the development computer 102, the storage devices 122 may include a reference application 121, a solution wizard 129, a configuration 124, an application generator 125, a generated application 127, and an integrated development environment (IDE) 128. The reference application 121 may be an enterprise application that includes projects, such as presentation layers, business layers, and data layers.

In an exemplary embodiment of the invention, the presentation layer may include a Web client, mobile client, and a desktop client. Additionally, the presentation layer may include a web service proxy and a web service. Further, the reference application 121 may include components such as reporting, workflows, rule engines, database scripts, and build scripts.

The application generator 125 may generate the generated application 127 using the reference application 121 as a source. The application generator 125 may select projects and components from the reference application 121 to include in the generated application 127 based on the configuration 124. The application generator 125 may place the generated application 127 in a new solution directory, with the selected projects and components pieced together to form a complete, ready to run, customized application.

The configuration 124 may specify the type of the generated application 127. For example, the generated application may be a desktop application, a service application, or a network application such as a Web application.

The configuration 124 may specify each project of the reference application 121, and an attribute describing each project. For example, the attribute may specify that a particular project is a client layer, a web service, a business layer, a data layer, etc. Additionally, the configuration 124 may specify criteria for determining whether to include each of the projects in the generated application 127. Additionally, the configuration may specify optional components that may be added to the generated application 127. In an exemplary embodiment of the invention, the configuration 124 may be specified in extended mark-up language (XML).

In an exemplary embodiment of the invention, the solution wizard 129 may be software that queries a user to specify some details about the generated application 127. For example, the solution wizard 129 may display a list of all optional components specified in the configuration 124 to the user. Using the solution wizard 129, the user may then select which of the optional components to include in the generated application 127. Additionally, the solution wizard 129 may query the user for the namespace of the generated application 127.

The IDE 128 may be a software application that provides comprehensive facilities to the user for software development. The IDE 128 may include a source code editor, a compiler and/or an interpreter, build automation tools, and a debugger. The IDE 128 may also include a version control system and various tools integrated to simplify the construction of user interfaces. Additionally, the IDE 128 may include a class browser, an object inspector, and a class hierarchy diagram, for object-oriented software development.

In an exemplary embodiment of the invention, the source code of the generated application 127 may be presented to the user in the IDE 128. As such, the user may further customize the generated application 127. The user may also use compilers and other tools to generate and install the implemented enterprise application 123 from the generated application 127.

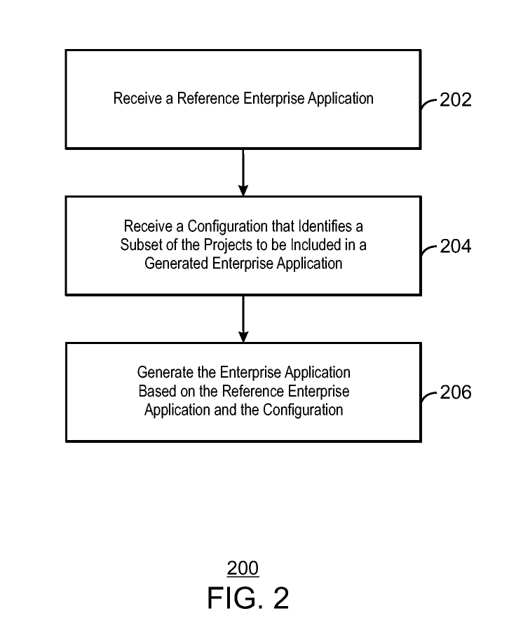

FIG. 2 is a process flow diagram of a computer-implemented method for generating an enterprise application, according to an exemplary embodiment of the present invention. The method is generally referred to by the reference number 200, and may be performed by the application generator 125 (FIG. 1). It should be understood that the process flow diagram for method 200 is not intended to indicate a particular order of execution.

The method begins at block 202, as the application generator 125 receives the reference enterprise application 121. In an exemplary embodiment of the invention, the user may select the reference enterprise application 121 from a system library of the enterprise.

At block 204, the application generator 125 may receive the configuration 124. As stated previously, the configuration 124 may specify the projects and components of the reference enterprise application 121 that are to be included in the generated application 127.

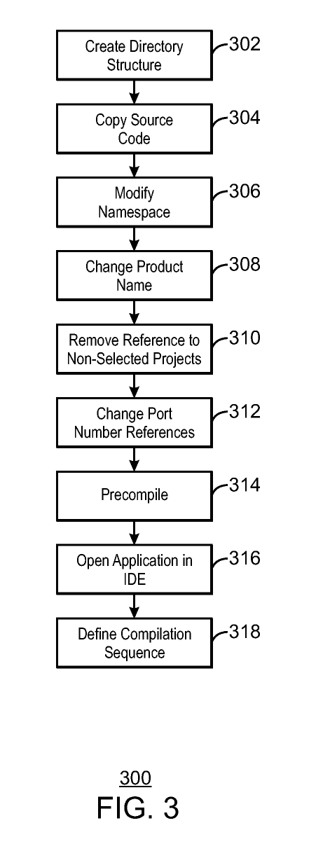

At block 206, the application generator 125 may generate the generated application 127. The generated application 127 may be a complete, ready to run, customized enterprise application. Block 206 is described in greater detail with reference to FIG. 3.

FIG. 3 is a process flow diagram of a computer-implemented method for generating an enterprise application, according to an exemplary embodiment of the present invention. The method is generally referred to by the reference number 206, and may be performed by the application generator 125. It should be understood that the process flow diagram for method 206 is not intended to indicate a particular order of execution.

The method begins at block 302, with the application generator 125 creating a directory structure. The directory structure may be a file organization system that contains the source code for all the projects and components of the generated application 127.

At block 304, the application generator 125 may copy the source code from the reference enterprise application 121 and store the source code in the directory structure. The source code copied from the reference enterprise application 121 may be selected based on the configuration 124.

As stated previously, the configuration 124 may specify all the projects in the reference enterprise application 121 that are to be included in the generated application. Additionally, the configuration 124 may specify, for each project, criteria for determining whether to include a particular project in the generated application.

At block 306, the application generator 125 may modify the namespace of source code files in the generated application 127. The namespace may identify a particular source code file in the generated application 127. Because the generated application 127 is copied from the reference enterprise application 121, the namespace of source code files in the generated application 127 may not accord with the generated application 127. Accordingly, the namespace of one or more source code files may be modified to new namespaces.

At block 308, the application generator 125 may modify the product name. The product name may be a name that references the entire generated application 127. As such, the copied source code files may include a product name for the reference enterprise application 121, and not the generated application. As such, all references to the product name in the copied source code files may be modified to a new product name for the generated application.

At block 310, the application generator 125 may remove references to non-selected projects from the generated application 127. The source code for the reference enterprise application 121 may include references to all the projects of the reference enterprise application. References may include calls to each of the projects. Because not all projects from the reference enterprise application 121 are included in the generated application 127, the generated application may not compile cleanly if the source code contains references to projects that are not included. As such, the application generator 125 may identify all projects not included in the generated application. Further, the application generator 125 may remove or alter lines of source code that reference projects that are not included in the generated application 127.

At block 312, the application generator 125 may change port number references in the source code of the generated application 127. Port numbers are typically used in network applications, such as Internet applications. The port numbers refer to a communication path from one computing device to another.

In an exemplary embodiment of the invention, port number references of the reference enterprise application 121 may not meet customer requirements for the generated application. For example, port numbers used in source code are typically default values. However, a customer's security concerns may be such that default values are insufficient. As such, the security concerns may be addressed by customizing port numbers in the generated application 127. As such, the application generator 125 may modify the port numbers reference in the source code of the generated application to fulfill a customer's requirements. In an exemplary embodiment of the invention, the solution wizard 129 may query the user to provide customized port numbers for the generated application.

At block 314, the application generator 125 may optionally pre-compile one or more of the projects of the generated application 127. For projects that are pre-compiled, any references to those projects in the source code of the generated application may be changed to reference the pre-compiled code, instead of the source code.

At block 316, the application generator 125 may open the generated application in the IDE 128. As stated previously, the IDE 128 may enable the user to view, modify, and compile the source code of the generated application 127.

At block 318, the application generator 125 may define a compilation sequence. The compilation sequence may be a particular order in which each source code file of the generated application may be compiled. The source code files of the generated application are interdependent. As such, compiling any of the source code files out of sequence may produce errors in the compilation.

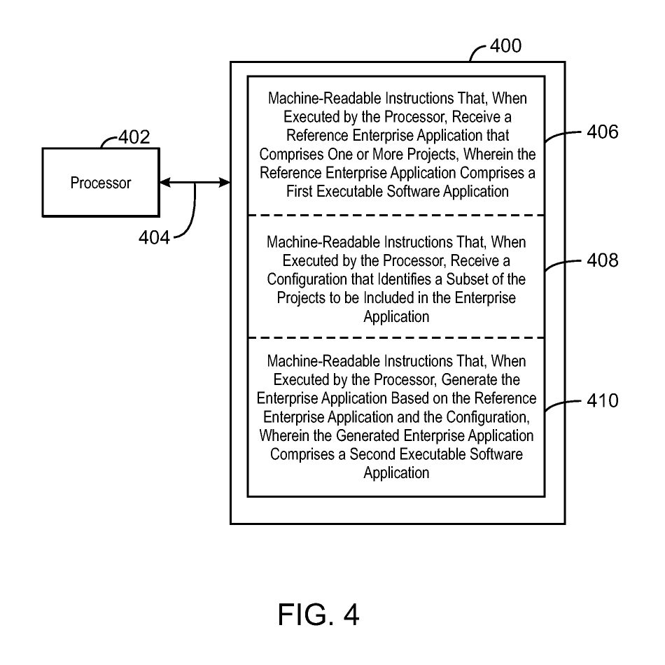

FIG. 4 is a block diagram showing a tangible, machine-readable medium that stores code adapted for generating an enterprise application according to an exemplary embodiment of the present invention. The tangible, machine-readable medium is generally referred to by the reference number 400. The tangible, machine-readable medium 400 may correspond to any typical storage device that stores computer-implemented instructions, such as programming code or the like. A computer program comprising the computer-implemented instructions stored on the tangible, machine-readable medium 400 may provide a technical effect of making software application development more efficient and economical.

Moreover, the tangible, machine-readable medium 400 may be included in the storage 122 shown in FIG. 1. When read and executed by a processor 402, the instructions stored on the tangible, machine-readable medium 400 are adapted to cause the processor 402 to generate an enterprise application.

A region 406 of the tangible, machine-readable medium 400 stores machine-readable instructions that, when executed by the processor 402, receive a reference enterprise application that comprises one or more projects, wherein the reference enterprise application comprises a first executable software application. The processor 402 may access the tangible, machine-readable medium 400 via a bus 404. A region 408 of the tangible, machine-readable medium 400 stores machine-readable instructions that, when executed by the processor 402, receive a configuration that identifies a subset of the projects to be included in the generated enterprise application.

A region 410 of the tangible, machine-readable medium 400 stores machine-readable instructions that, when executed by the processor 402, generate the enterprise application based on the reference enterprise application and the configuration, wherein the generated enterprise application comprises a second executable software application.

What is claimed is:

1. A computer system (102) for generating an enterprise application (123), the computer system (102) comprising:
a processor (112) adapted to execute stored instructions; and
a memory device (122) that stores instructions for execution by the processor (112), the memory device (122) comprising:
computer-implemented code adapted to receive a reference enterprise application (121) that comprises one or more projects, wherein the reference enterprise application (121) comprises a first executable software application;
computer-implemented code adapted to receive a configuration (124) that identifies a subset of the projects to be included in the enterprise application (123); and
computer-implemented code adapted to generate the enterprise application (123) based on the reference enterprise application (121) and the configuration (124), wherein the generated enterprise application (123) comprises a second executable software application.

2. The computer system (102) of claim 1, wherein the projects comprise one or more of:
a presentation layer;
a web services layer;
a business logic layer; and
a data layer.

3. The computer system (102) of claim 1, wherein the enterprise application (123) comprises one or more components, wherein the components comprise one or more of:
a reporting component;
a workflow;
a rule engine;
a database script; and
a build script.

4. The computer system (102) of claim 3, comprising computer-implemented code adapted to receive one or more selections that specify the components.

5. The computer system (102) of claim 1, wherein the computer-implemented code adapted to generate the enterprise application (123) comprises computer-implemented code adapted to copy source code of the subset of projects to source code of the enterprise application (123).

6. The computer system (102) of claim 5, comprising:
computer-implemented code adapted to pre-compile one of the subset of projects; and
computer-implemented code adapted to modify a reference to source code of the pre-compiled project to the pre-compiled project.

7. The computer system (102) of claim 5, comprising computer-implemented code adapted to create a file directory structure comprising:
a name of the enterprise application; and
the source code of the enterprise application.

8. The computer system (102) of claim 5, comprising computer-implemented code adapted to modify a product name in the enterprise application from a product name of the reference enterprise application to a product name of the enterprise application.

9. A tangible, machine-readable medium (400) that stores machine-readable instructions executable by a processor (402) to execute a query, the tangible, machine-readable medium (400) comprising:
machine-readable instructions (406) that, when executed by the processor, receive a reference enterprise application that comprises one or more projects, wherein the reference enterprise application comprises a first executable software application;
machine-readable instructions (408) that, when executed by the processor, receive a configuration that identifies a subset of the projects to be included in the enterprise application; and
machine-readable instructions (410) that, when executed by the processor, generate the enterprise application based on the reference enterprise application and the configuration, wherein the generated enterprise application comprises a second executable software application.

10. The tangible, machine-readable medium (400) of claim 9, wherein the machine-readable instructions (410) that, when executed by the processor, generate the enterprise application, comprise machine-readable instructions that, when executed by the processor, copy source code of the subset of projects to source code of the enterprise application.

11. The tangible, machine-readable medium (400) of claim 10, comprising machine-readable instructions that, when executed by the processor, modify each namespace of the subset of projects to a pre-determined namespace.

12. The tangible, machine-readable medium (400) of claim 10, comprising machine-readable instructions that, when executed by the processor, modify a product name in the enterprise application from a product name of the reference enterprise application to a product name of the enterprise application.

13. A computer system (102) for generating an enterprise application, comprising:
means for receiving a reference enterprise application that comprises one or more projects, wherein the reference enterprise application comprises a first executable software application;
means for identifying a subset of the projects to be included in the enterprise application; and
means for generating the enterprise application based on the reference enterprise application and the configuration, wherein the generated enterprise application comprises a second executable software application.

14. The computer system (102) of claim 13, wherein the means for generating the enterprise application comprise means for copying source code of the subset of projects to source code of the enterprise application.

15. The computer system (102) of claim 13, comprising means for removing references from the enterprise application to projects that the enterprise application does not comprise.
